(19) United States
(12) Patent Application Publication
(10) Pub. No.: US 2024/0417970 A1
(43) Pub. Date: Dec. 19, 2024

(54) Anchor Bolt Locator

(71) Applicant: Simpson Strong-Tie Company Inc., Pleasanton, CA (US)

(72) Inventors: Louay A Shamroukh, Discovery Bay, CA (US); Michael Nagasev, Stockton, CA (US)

(21) Appl. No.: 18/211,209

(22) Filed: Jun. 16, 2023

(51) Int. Cl. E04B 1/41

(52) U.S. Cl. CPC E04B 1/4157

(57) ABSTRACT

An anchor bolt locator is provided that is inexpensively manufactured on automatic die-press machines from sheet steel and a structural nut that does not require any welding, while also being easy to use and install with current, commonly-used building practices and anchor designs. The anchor bolt locator is made from a galvanized sheet metal chair and a structural nut is encased in the chair.

### BACKGROUND OF THE INVENTION

The present invention relates to a concrete embedded insert, called an anchor bolt locator, for properly locating and supporting a bolt or anchoring member during the pouring and curing of a concrete member, such that the bolt will be properly placed in the cured concrete.

A concrete slab member is a common structural element of modern buildings. Horizontal slabs of steel-reinforced concrete are used to construct slab foundations, floors, ceilings, roofs, decks and exterior paving.

Concrete slabs are built using a formwork-a type of boxing into which the wet concrete is poured and then cured. Typically, if the slab is to be reinforced, steel reinforcing rods are used, and these are positioned within the formwork before the concrete is poured. This steel reinforcing is often called rebar. Metal or plastic chairs are typically used to hold the reinforcing rods away from the bottom and sides faces of the formwork, so that when the concrete sets it completely envelops the reinforcing rods. For a slab resting on the ground, the formwork may consist only of sidewalls pushed into or set up on the ground. For a suspended slab, the formwork is shaped like a tray, often supported by a temporary scaffold until the concrete sets. The formwork is commonly built from planks and boards made from wood, plastic, steel or reinforced foam members. After the concrete has set the formwork can be removed or remain in place. In some cases formwork is not necessary—for instance, a ground slab surrounded by brick or block foundation walls, where the walls act as the sides of the tray and the hardcore earth acts as the base.

Concrete slab members are also typically built in a manner that allows for anchor members and fasteners to be built into the slab so that other building elements can be easily and securely anchored in or attached to the concrete member. It is very common to see a slab with many different bolts and fasteners protruding from or disposed at the surface of the the slab after it has cured and the formwork has been removed. These preset anchors or inserts are typically used for securing pipes or conduits to concrete ceilings, or for securing framing to a concrete foundation or floor.

When anchors such as bolts and threaded rod are to be embedded in a concrete slab, they must be supported during the concrete pour. It is important that the anchors are located properly in the slab and remain undisturbed during the pour, so that subsequent building elements can be attached to them easily. The proper location of anchors in slabs is especially important for decks where the anchor will fasten a safety railing to the deck and for lateral force resisting systems where the anchors must be placed carefully to provide the proper anchorage without interfering with other structural members. Proper location is also important for the integrity of the anchor and the strength of the anchorage. If the anchor is set too close or at an improper angle so that portions of the anchor are too close to the sides of the slab, water penetrating into the slab can degrade the anchor. The strength of the anchorage is also compromised if there is insufficient concrete surrounding the anchor.

Typically, certain of the anchors located in the slab will be located close enough to the edges of the slab that they can be supported by a member attached to the side formwork during the pour. Other anchors will be located so far away from the sides of the form that it is best to support them in some other manner. Sometimes the anchors can be tied to and supported by the reinforcing rods. Other times it is preferable to support the anchor on the underlying surface of the formwork. The present invention is a free-standing anchor bolt locator that can be attached to the underlying formwork and holds an anchor or bolt during the concrete pour. Many such devices appear in the patent literature, including: U.S. Pat. No. 5,957,644, granted Sep. 28, 1999, to James A. Vaughan, U.S. Pat. No. 5,050,364, granted Sep. 24, 1991, to Michael S. Johnson et. al., and U.S. Pat. No. 5,205,690, granted Apr. 27, 1993, to Steven Roth.

The present invention improves upon the prior art by providing an anchor bolt locator that is inexpensively manufactured on automatic die-press machines from sheet steel and a structural nut that does not require any welding, while also being easy to use and install with current, commonly-used building practices and anchor designs.

### SUMMARY OF THE INVENTION

It is an object of the present invention is to provide an anchor bolt locator, and a method for making an anchor bolt locator that is economically efficient to produce. It is also an object of the present invention to provide an anchor bolt locator that is easy to use and install. These objects are achieved by forming the chair of the anchor bolt locator out of sheet metal, and forming the anchor bolt locator in such a way that a structural nut can be strongly attached to the sheet metal chair without having to weld the nut to the chair. In this manner an anchor bolt locator is formed that can receive a piece of threaded rod in the nut in the typical fashion currently used for creating threaded rod anchorages with the nut at the proper height for such an anchorage. This type of anchorage is typical in the industry and in some instances uses two structural nuts sandwiching a structural plate washer between them. The structural nut of the present invention is designed to serve as the lower nut for a double-nut and plate washer anchorage. By avoiding welding the nut to the chair the structural integrity of the nut is better preserved, and the process does not need to include a welding station. Welding can crack nuts, especially if they are heat treated.

It is also an object of the present invention to provide an anchor bolt locator where the connection between the threaded rod and the locator is easily made. This object is achieved in part by providing a shelf that also serves as a stop to prevent the anchor from being inserted too far into the structural nut. The threaded rod is rotated into the nut and the shelf that supports the structural nut stops the threaded rod from being inserted farther than is necessary into the nut. If the anchor is threaded too far into the nut, the bottom of the anchor may be placed too close to the bottom of the concrete form which can lead to degradation of the anchor, and it will also mean that less of the anchor protrudes from the top of the form for attaching other devices.

### BRIEF DESCRIPTION OF THE DRAWINGS

FIG. 1 is a perspective view of an anchor bolt locator of the present invention.

FIG. 2 is a left side view of the anchor bolt locator of FIG. 1.

FIG. 3 is right side view of the anchor bolt locator of FIG. 1.

FIG. 4 is a front view of the anchor bolt locator of FIG. 1.

FIG. 5 is a back view of the anchor bolt locator of FIG. 1.

FIG. 6 is a plan view of the anchor bolt locator of FIG. 1.

FIG. 7 is a bottom view of the anchor bolt locator of FIG. 1.

FIG. 8 is perspective view of the anchor bolt locator of FIG. 1 attached to a concrete slab form.

FIG. 9 is a side view of the anchor bolt locator of FIG. 1 attached to and set in a cured concrete slab form with an anchor attached to the anchor bolt locator and protruding from the cured concrete.

FIG. 10 is a perspective view of an anchor bolt locator of the present invention.

FIG. 11 is a left side view of the anchor bolt locator of FIG. 10.

FIG. 12 is right side view of the anchor bolt locator of FIG. 10.

FIG. 13 is a front view of the anchor bolt locator of FIG. 10.

FIG. 14 is a back view of the anchor bolt locator of FIG. 10.

FIG. 15 is a plan view of the anchor bolt locator of FIG. 10.

FIG. 16 is a bottom view of the anchor bolt locator of FIG. 10.

FIG. 17 is a perspective view of an anchor bolt locator of the present invention.

FIG. 18 is a left side view of the anchor bolt locator of FIG. 17.

FIG. 19 is right side view of the anchor bolt locator of FIG. 17.

FIG. 20 is a front view of the anchor bolt locator of FIG. 17.

FIG. 21 is a back view of the anchor bolt locator of FIG. 17.

FIG. 22 is a plan view of the anchor bolt locator of FIG. 17.

FIG. 23 is a bottom view of the anchor bolt locator of FIG. 17.

### DETAILED DESCRIPTION OF THE INVENTION

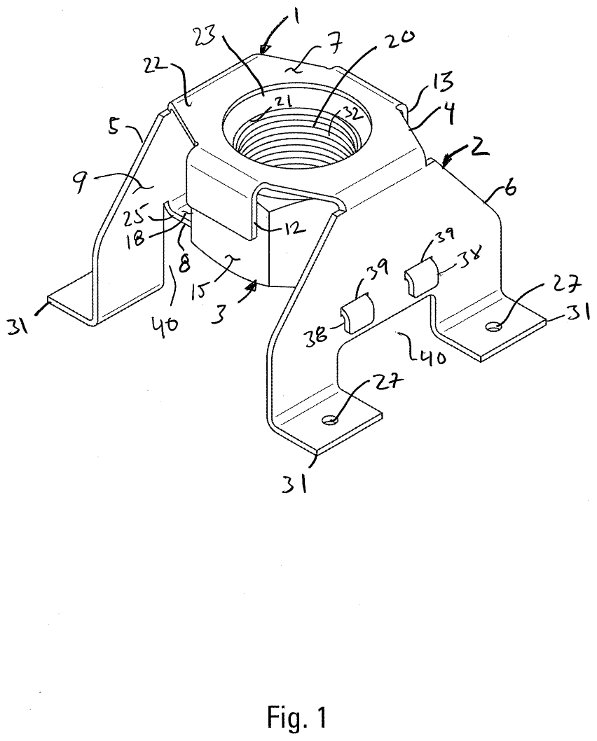

FIG. 1, shows the preferred, non-welded anchor bolt locator 1 of the present invention made from a galvanized sheet metal chair 2 and a structural nut 3 attached to the chair 2.

As shown in FIG. 1, preferably the chair 2 of the anchor bolt locator 1 is a generally u-shaped body having a bridge 4 that connects first and second legs 5 and 6. Preferably, the bridge 4 is substantially planar. The bridge 4 can be formed with a plurality of pairs of opposed sides and the first and second legs 5 and 6 of the chair 2 are connected to the bridge 4 at one pair of opposed sides. Preferably, the legs 5 and 6 of the chair 2 depend from the bridge 4 at right angles to the bridge 4. Preferably, the plurality of legs 5 and 6 extend below and away from the top surface 7 of the bridge 4.

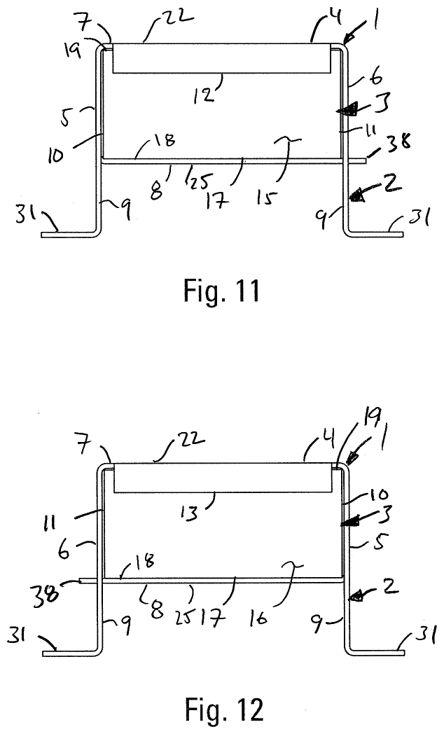

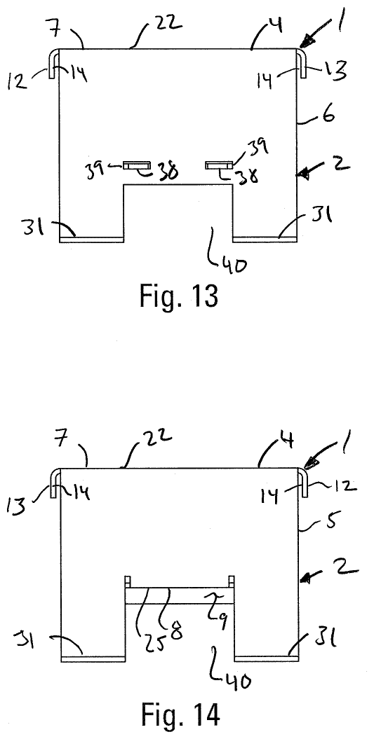

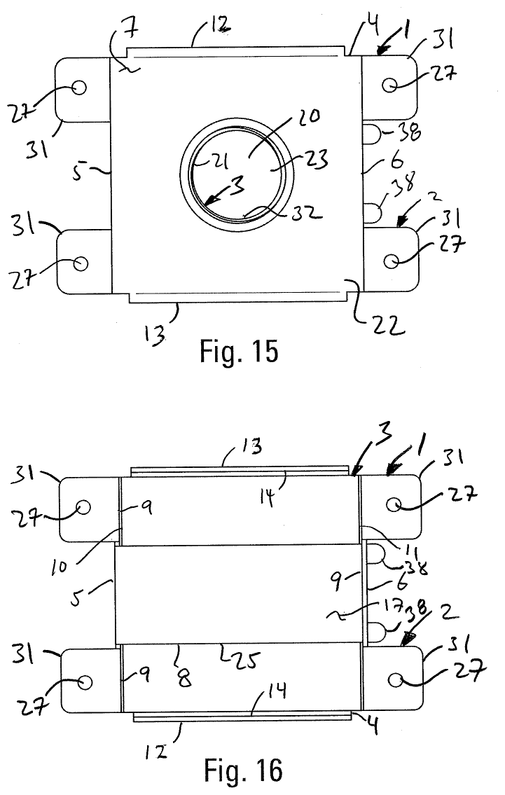

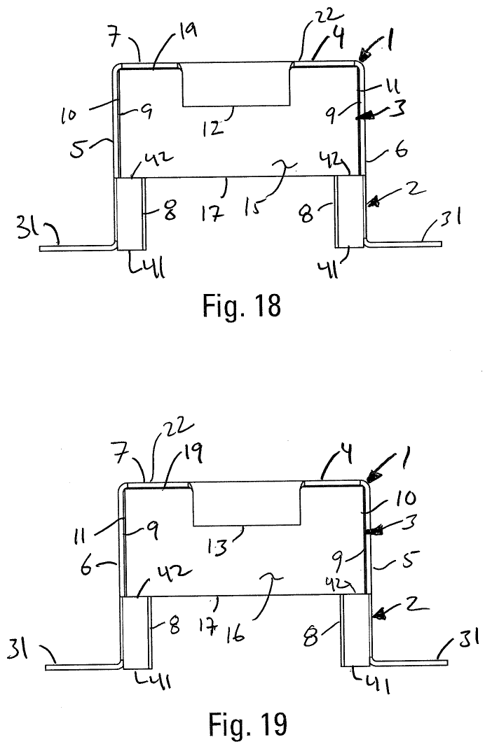

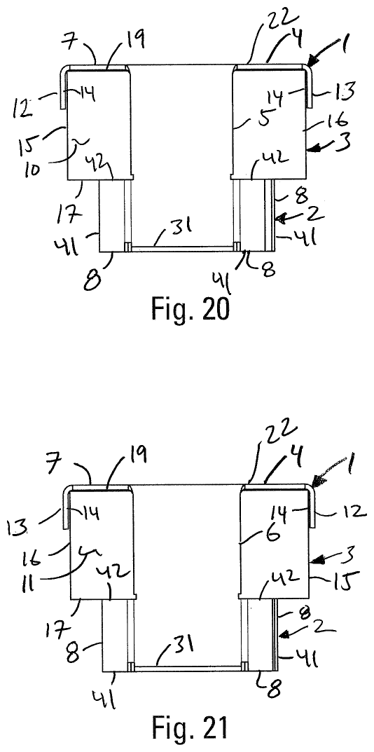

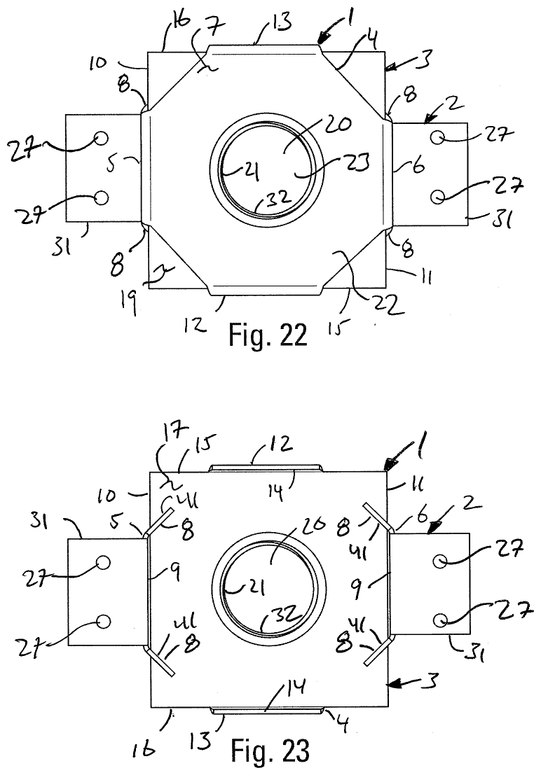

As shown in FIGS. 1, 2, 11 and 18, the chair 2 is formed with a support 8 that supports the structural nut 3. The structural nut 3 is constrained by various members of the chair 2 and is held securely in place and cannot rotate with respect to the chair 2. The inner surfaces 9 of the first and second legs 5 and 6 engage with or lie closely adjacent opposed first and second outer side panels 10 and 11 of the nut 3 and prevent rotation of the structural nut 3 with respect to the chair 2. First and second opposed flanges 12 and 13 of the chair 2 can be connected to the bridge 4 at another pair of opposed sides of the bridge 4. Preferably, the opposed flanges 12 and 13 of the chair 2 depend from the bridge 4 at right angles to the bridge 4. Preferably, the plurality of opposed flanges 12 and 13 extend away from the top surface 7 of the of the bridge 4. The inner surfaces 14 of the first and second opposed flanges 12 and 13 engage with or lie closely adjacent opposed third and fourth outer side panels 15 and 16 of the nut 3, and also prevent rotation of the structural nut 3 with respect to the chair 2. Preferably, the outer side panels 10, 11, 15 and 16 of the nut 3 are made with flat faces, and the nut has a polygonal cross-section. The bottom end 17 of the nut 3 is supported on the top surface 18 of the support 8.

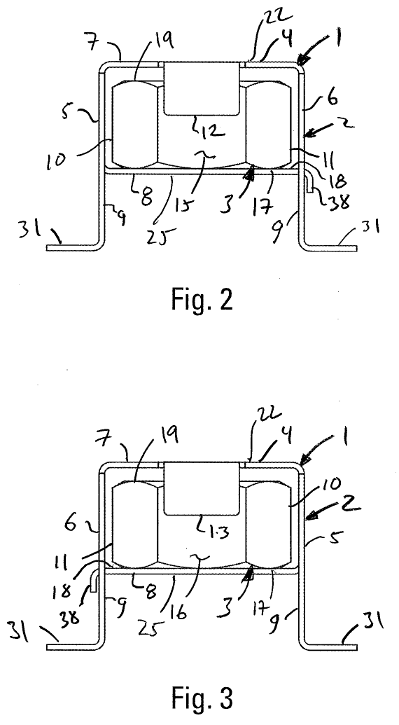

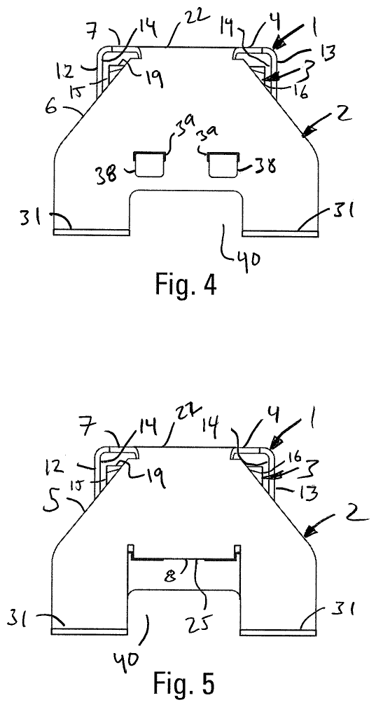

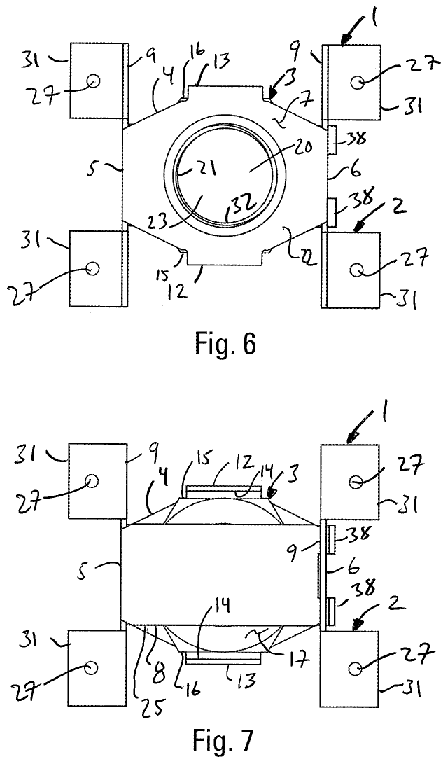

As shown in FIGS. 1 and 2, the structural nut 3 has a top end 19, a bottom end 17, an internal, threaded bore 20 forming an internal, threaded side wall 21, and one or more outer side panels 10, 11, 15 and 16. As shown in FIGS. 1, 11, and 18, the bottom end 17 of the structural nut 3 can rest on the top surface 18 of the support 8, and portions of the outer walls 10, 11, 15 and 16 of the structural nut 3 are in contact with portions of the legs 5 an 6 and the flanges 12 and 13 such that the structural nut 3 is secured to the chair 2.

As shown in FIG. 1, preferably, the outer side panels 10, 11, 15 and 16 of the structural nut 3 extend at a right angle to the top and bottom ends 19 and 17 of the nut 3. Preferably, the legs 5 and 6 and the flanges 12 and 13 extend at right angles to the generally planar portion 22 of the bridge 4 surrounding an opening 23 in the bridge 4, and the generally planar portion 22 of the bridge 4 extends at a right angle to the outer side panels 10, 11, 15 and 16 of the structural nut 3.

Since the anchor bolt locator 1 is preferably made from thin sheet steel the bridge 4 and legs 5 and 6 are, preferably, generally planar, thin members. Preferably, a portion 22 of the bridge 4 surrounding the opening 23 in the bridge of the chair 2 is a substantially planar and relatively thin member. As such, the structural nut 3 between the top end 19 and the bottom end 17 will have a thickness that is substantially greater than the relatively thin portion 22 of the bridge 4 surrounding the opening 23.

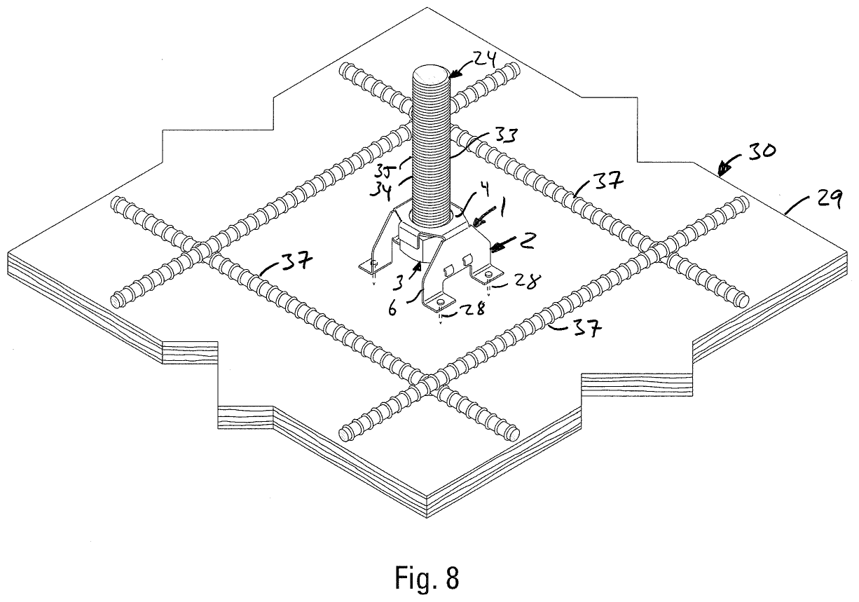

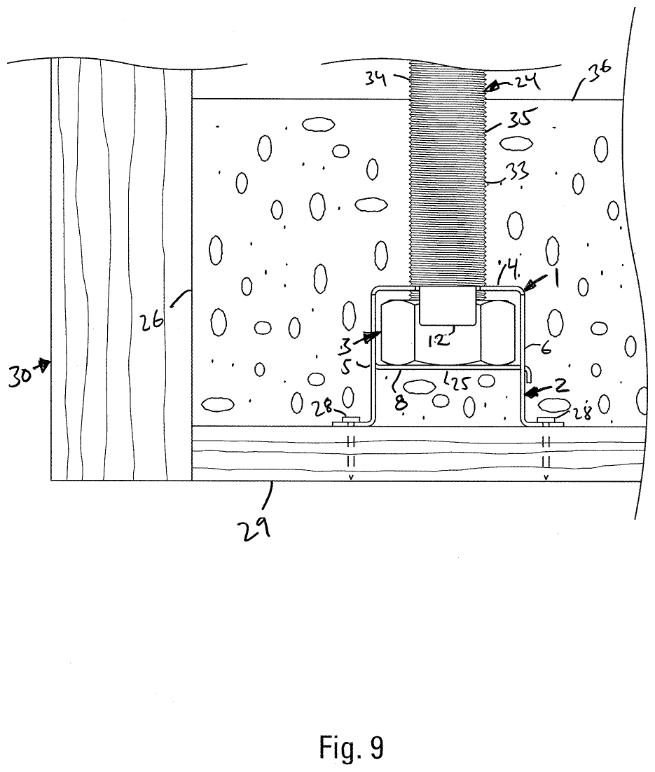

As shown in FIGS. 8 and 9, an anchor or threaded rod 24 is attached to the structural nut 4. As shown in FIGS. 7 and 16 the support 8 can be a shelf 25 formed from one of the plurality of legs 5 and 6 that extends underneath the structural nut 3. Preferably the shelf 25 extends sufficiently past the internal side wall 21 of the structural nut 3 so as to block the passage created by the internal bore 20 so as to interfere and stop the travel of any threaded rod or anchor 24 received and threaded into the internal passage 20 of the nut 3 much beyond the bottom end 17 of the structural nut 3.

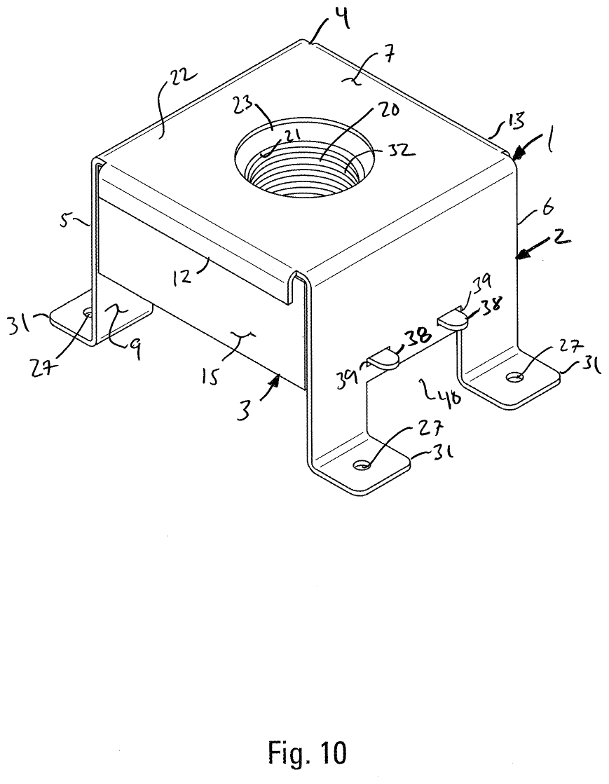

As shown in FIGS. 1 and 10, legs 5 and 6 of the chair 2 can be formed with a flow passage 40 to ensure that concrete 26 flows around and under the anchor bolt locator 1 and the threaded rod 24 attached to the nut 3.

Mounting holes 27 are provided in the chair 2. As shown in FIGS. 8 and 9, fasteners 28, preferably nails when the form board bottom 29 is wood, are inserted through the mounting holes 27 and fastened to the form board decking 29, securing the anchor bolt locator 1 to the form 30 in the desired location.

The anchor bolt locator 1 is preferably formed from galvanized, stainless-steel formed in a sheet. In the preferred method of making the anchor bolt locator 1, any openings that are to be made in the chair 2 are formed first, usually with or right after the blank for the chair 2 is cut from the sheet stock. Then the legs 5 and 6, the shelf 25 and feet 31 connected to the legs 5 and 6 are bent and formed.

The attachment between the anchor 24 and the nut 3 is made by means of corresponding threads 32 and 33 in the internal cavity or bore 20 of the structural nut 3 and on the outer surface 34 of the anchor 24. As shown in FIG. 9, the anchor 24 is formed with an elongated shank 35 that can protrude above the top level 36 of the concrete slab 26.

As shown in FIG. 1, feet 31 extend orthogonally from legs 5 and 6, and the mounting holes 31 for fasteners 28 are preferably formed in feet 31.

As shown in FIGS. 1, 2 and 3, shelf 25 is formed from and bent from leg 5 at one end of shelf 25. Shelf 25 is preferably disposed parallel to bridge 4. Shelf 25 engages the bottom end 17 of structural nut 3. Flanges 12 and 13 together with legs 5 and 6 and bridge 4 and shelf 25 substantially encapsulate and hold the structural nut 3 in place such that structural nut 3 is supported and does not rotate with respect to chair 2. The opposed end of shelf 25 is formed with a plurality of engagement tabs 38 that are inserted in and through engagement openings 39 formed in leg 6. The engagement openings 39 support shelf 25. The ends of engagement tabs 38 can be bent so as to prevent their withdrawal from engagement openings 39.

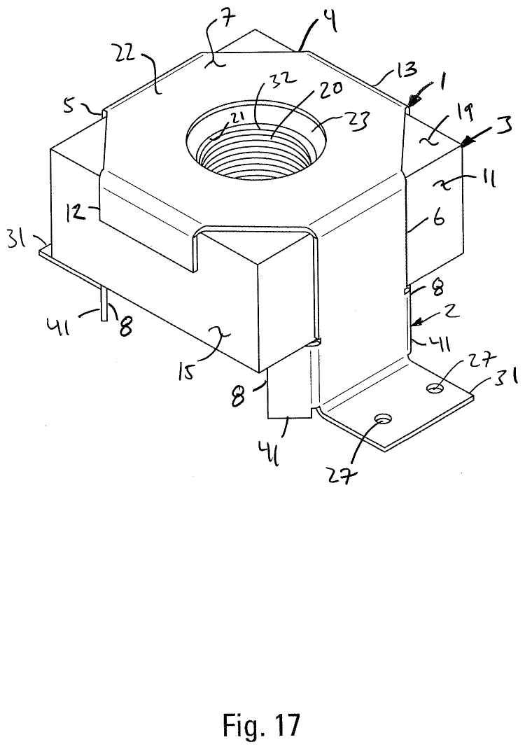

As shown in FIGS. 17 and 23, legs 5 and 6 can be formed with support tabs 41 that are bent from and project inwardly from support legs 5 and 6. Support tabs are bent from vertical bend lines in legs 5 and 6. Support tabs 41 have top edges 42 that support the bottom end 17 of the structural nut 3. Preferably, legs 5 and 6 can each be formed with two support tabs 41. As shown in FIG. 23, preferably support tabs 41 are bent at a non-orthogonal angle to legs 5 and 6.

FIGS. 8 and 9 illustrate use of the invention. The anchor bolt locator 1 is used with a wood form 30 into which concrete 26 will be poured. In FIG. 8, rebar members 37, a specific type of steel concrete reinforcing member, are shown placed in the form 30. The installer nails or screws the anchor bolt locator 1 to the bottom 29 of the form 30 by running the fasteners 28 through the mounting holes 27 in the anchor bolt locator 1. Once the anchor bolt locator 1 is firmly fastened to the bottom 29 of the formwork 30, the appropriate anchor 24 or threaded rod is inserted and threaded onto the nut 3, and if present, the shelf 25 stops further downward travel. A washer (not shown) can be placed over or pre-attached to the anchor 24 so that it rests on the top surface 7 of the bridge 4 and a second structural nut (not shown) can be threaded onto the anchor 24 so that it engages the top surface of the washer. This type of double-nut-washer anchorage is commonly used in the industry. The components are readily available and inexpensive, and yet well documented for their performance as anchors. Concrete 26 is then poured into the formwork 30, so that the anchor bolt locator 1, the structural nuts and the washer, and the bottom portion of the threaded rod 24 are all surrounded and embedded in the concrete 26 with the top of the threaded rod or anchor 24 protruding from the top surface 36 of the concrete 26. When the concrete 26 hardens the form 30 can be removed. If there is access to the bottom 29 of the form 30, it can be removed as well and the ends of the fasteners 28 that were driven into the bottom formwork 29 can be broken off where they protrude from the concrete foundation 26.

We claim:

1. An anchor bolt locator, comprising:
a. a chair, having a plurality of legs, a bridge connecting the legs, said bridge having a top surface, with the plurality of legs extending from the bridge in the same direction away from said top surface of said bridge;
b. a support connected to one or more of the plurality of the legs extending from the bridge, the support being disposed below the bridge; and
c. a structural nut disposed below the bridge, the structural nut has a top end and a bottom end, and the bottom end is supported by the support.

2. The anchor bolt locator of claim 1, wherein:
the structural nut has an internal, threaded bore forming an internal, threaded side wall, said structural nut also having an outer side wall, made up of one or more adjoining outer side panels, defining an outer surface of said structural nut.

3. The anchor bolt locator of claim 2, wherein:
at least two of the plurality of the legs engage with or lie closely adjacent to the outer side wall of the nut, preventing the structural nut from rotating with respect to the chair.

4. The anchor bolt locator of claim 3, wherein:
the at least two of the plurality of legs are opposed to each other and engage opposed side panels of the structural nut.

5. The anchor bolt locator of claim 2, wherein:
a. the chair is formed with a plurality of flanges, the plurality of flanges extending from the bridge in the same direction away from the top surface of the bridge; and
b. at least two of the plurality of the flange engage with or lie closely adjacent to the outer side wall of the nut, preventing the structural nut from rotating with respect to the chair.

6. The anchor bolt locator of claim 5, wherein:
the at least two of the plurality of legs are opposed to each other and engage opposed side panels of the structural nut.

7. The anchor bolt locator of claim 6, wherein:
the at least two of the plurality of the legs engage with or lie closely adjacent to the outer side wall of the nut, preventing the structural nut from rotating with respect to the chair.

8. The anchor bolt locator of claim 7, wherein:
at least two of the plurality of legs are opposed to each other and engage opposed side panels of the structural nut.

9. The anchor bolt locator of claim 1, wherein:
the support is a shelf disposed below the bridge, the shelf being a generally planar member with the shelf being connected to one of the plurality of legs, the shelf having a top surface upon which the bottom end of the structural nut rests.

10. The anchor bolt locator of claim 1, wherein:
a. the structural nut has an internal bore forming an internal side wall; and
b. a portion of the shelf covers a portion of the internal bore.

11. The anchor bolt locator of claim 9, wherein:
a. at least two of the plurality of legs are opposed to each other; and
b. the shelf if formed from and bent from one of the at least two of the plurality of legs which are opposed to each other and connects to the other of the at least two of the plurality of legs which are opposed to each other, and the shelf is disposed parallel to the bridge.

12. The anchor bolt locator of claim 12, wherein:
an end of the shelf if formed with one or more engagement tabs that are inserted in one or more engagement openings in one of the plurality of legs of the chair.

13. The anchor bolt locator of claim 1, wherein:
the support is one or more support tabs disposed below the bridge, the one or more support tabs being generally vertically disposed with the one or more support tabs being connected to one or more of the plurality of legs, the one or more support tabs having top edges upon which the bottom end of the structural nut rests.

14. A connection between an anchor and a cement formwork by an anchor bolt locator, said connection comprising:
a. said foundation formwork, having one or more side walls and a bottom, said bottom having a top surface,
b. an anchor bolt locator attached to said top surface of said bottom, said anchor bolt locator, including:
1. a chair, having a plurality of legs, a bridge connecting the legs, said bridge having a top surface, with the plurality of legs extending from the bridge in the same direction away from said top surface of said bridge, said plurality of legs resting on said top surface of said bottom of said foundation formwork;
2. a support connected to one or more of the plurality of the legs extending from the bridge, the support being disposed below the bridge;
3. a structural nut disposed below the bridge, the structural nut supported by the support, the structural nut having an internal bore;
c. a plurality of fasteners inserted through mounting openings in said chair and inserted into said bottom of said cement formwork, such that said anchor bolt locator is firmly secured to said bottom; and
d. said anchor is received in said internal bore of said structural nut.

15. The anchor bolt locator of claim 14, wherein:
the structural nut has an internal, threaded bore forming an internal, threaded side wall, said structural nut also having an outer side wall, made up of one or more adjoining outer side panels, defining an outer surface of said structural nut.

16. The anchor bolt locator of claim 15, wherein:
at least two of the plurality of the legs engage with or lie closely adjacent to the outer side wall of the nut, preventing the structural nut from rotating with respect to the chair.

17. The anchor bolt locator of claim 16, wherein:
the at least two of the plurality of legs are opposed to each other and engage opposed side panels of the structural nut.

18. The anchor bolt locator of claim 15, wherein:
a. the chair is formed with a plurality of flanges, the plurality of flanges extending from the bridge in the same direction away from the top surface of the bridge; and
b. at least two of the plurality of the flange engage with or lie closely adjacent to the outer side wall of the nut, preventing the structural nut from rotating with respect to the chair.

19. The anchor bolt locator of claim 18, wherein:
the at least two of the plurality of legs are opposed to each other and engage opposed side panels of the structural nut.

20. The anchor bolt locator of claim 19, wherein:
the at least two of the plurality of the legs engage with or lie closely adjacent to the outer side wall of the nut, preventing the structural nut from rotating with respect to the chair.

21. The anchor bolt locator of claim 20, wherein:
at least two of the plurality of legs are opposed to each other and engage opposed side panels of the structural nut.

22. The anchor bolt locator of claim 14, wherein:
the support is a shelf disposed below the bridge, the shelf being a generally planar member with the shelf being connected to one of the plurality of legs, the shelf having a top surface upon which the bottom end of the structural nut rests.

23. The anchor bolt locator of claim 14, wherein:
a. the structural nut has an internal bore forming an internal side wall; and
b. a portion of the shelf covers a portion of the internal bore.

24. The anchor bolt locator of claim 22, wherein:
a. at least two of the plurality of legs are opposed to each other; and
b. the shelf if formed from and bent from one of the at least two of the plurality of legs which are opposed to each other and connects to the other of the at least two of the plurality of legs which are opposed to each other, and the shelf is disposed parallel to the bridge.

25. The anchor bolt locator of claim 23, wherein:
an end of the shelf if formed with one or more engagement tabs that are inserted in one or more engagement openings in one of the plurality of legs of the chair.

26. The anchor bolt locator of claim 14, wherein:
the support is one or more support tabs disposed below the bridge, the one or more support tabs being generally vertically disposed with the one or more support tabs being connected to one or more of the plurality of legs, the one or more support tabs having top edges upon which the bottom end of the structural nut rests.
